(19) United States
(12) Patent Application Publication
(10) Pub. No.: US 2019/0171540 A1
(43) Pub. Date: Jun. 6, 2019

(54) APPARATUS FAULT DETECTING SYSTEM AND FAULT DETECTION DEVICE

(71) Applicant: Ke XU, Beijing (CN)

(72) Inventor: Ke XU, Beijing (CN)

(21) Appl. No.: 16/322,377

(22) PCT Filed: Aug. 25, 2017
(86) PCT No.: PCT/CN2017/098965

§ 371 Date: Jan. 31, 2019

(30) Foreign Application Priority Data
Aug. 25, 2016 (CN) 201610727251.9
Dec. 23, 2016 (CN) 201611208385.6

(51) Int. Cl. G06F 11/263; G06F 11/36

(52) U.S. Cl. CPC G06F 11/263; G06F 11/3668

(57) ABSTRACT

The application provides an apparatus fault detection system comprising a fault detection device and a terminal apparatus. The fault detection device operates independently from a target to be checked. The fault detection device is configured to obtain self-checking data and/or checked data of the target to be checked, identify fault information in the self-checking data and/or checked data, generate according to the fault information a fault diagnosis result, and transmit the same to the terminal apparatus. The terminal apparatus is configured to receive and display the fault diagnosis result. The terminal apparatus and the target to be checked are configured to transmit information to each other. Therefore, the embodiment is utilized to mitigate a technical problem in the prior art in which fault detection and alarm system is limited to employing an online detection method and a passive detection method to detect a fault in hardware such as a computer.

### CROSS REFERENCE TO RELATED APPLICATION

The present disclosure claims the priority to Chinese patent application No. 2016107272519, titled “DATA CENTER INTELLIGENT APPARATUS FAULT DETECTION SYSTEM” filed with the Chinese patent Office on Aug. 28, 2016, and Chinese patent application No. 2016112083856, titled “EMBEDDED INTELLIGENT APPARATUS FAULT DETECTION SYSTEM” filed with the Chinese patent Office on Dec. 23, 2016, the entire disclosures of which are incorporated herein by reference.

### FIELD

The present disclosure relates to the technical field of computer and electromechanical device maintenance, and in particular, to a system for device fault detection and an apparatus for fault detection.

### BACKGROUND

For a long time, the actual maintenance on hardware of bottom layers for various electromechanical device and products from computer manufacturers basically utilizes manual detection, or utilizes automatic detection and displays on a directly connected screen. Then, technicians manually distinguish and correct the fault. Namely, in conventional technology, the fault detection on the electromechanical device (including computers and security systems) is finally conducted by experienced engineers observing and determining faults in real time at the site.

There are some remote and automatic diagnostic methods in conventional technology. The methods include application monitoring, mobile APP remote control, etc., all of which log into a system interface through products or devices, and learn about problems through relevant online commands. The methods are based on an application level or a system level, which may not be able to actually identify a fault component. Such inspection methods are similar to network-based management or inspection methods. The detected hardware problems are sometimes only related to a software fault. In particular, in a case that the device is in a state of network stuck, network disconnection, machine halt, machine crash, or even being powered off, the users and maintenance personnel cannot learn about accurate information of the sudden fault, or replace the large and expensive complete machine integrally. In addition, the network detection method mentioned above occupies large traffic resources. Hence, a final stage of maintenance testing (“the last mile”) is manual rather than automatic.

Device manufacturers generally pay much attention to usage and less attention to maintenance. Functions for usage keep changing, and means for maintenance keep unchanged, which makes maintenance work extremely difficult, heavy, and boring.

### SUMMARY

To address the above issues, the present disclosure aims to provide a system for device fault detection. The system includes an apparatus for fault detection and a terminal device. The apparatus for fault detection operates independently from a to-be-tested target;

the apparatus for fault detection is configured to collect a self-test data and/or a test data of the to-be-tested target, identify fault information from the self-test data and/or the test data, generate a fault diagnosis result based on the fault information, and send the fault diagnosis result to the terminal device;

the terminal device is configured to receive and display the fault diagnosis result, and communicate with the to-be-tested target.

Optionally, in the aforementioned system, the system for device fault detection is configured to perform an offline fault diagnosis on a physical layer of the to-be-tested target and acquire an offline fault diagnosis result automatically, based on the self-test data and/or the test data, in a case that the to-be-tested target is in a state of machine-halt or network disconnection.

Optionally, in the aforementioned system, the system for device fault detection performs fault detection on target hardware and target software of a physical layer of the to-be-tested target, based on an operating system and an application software of the system for device fault detection, where the target software includes at least one of initial startup software for the to-be-tested target or testing software for the to-be-tested target. The system for device fault detection further includes a data processing apparatus, configured to integrate the offline fault diagnosis result into an online fault diagnosis result, where the online fault diagnosis result is a fault diagnosis result obtained in a case that the system for device fault detection performs an online fault diagnosis on a system layer and an application layer of the to-be-tested target.

Optionally, in the aforementioned system, the apparatus for fault detection is arranged independently outside the to-be-tested target, and includes a signal collection module, a control module and a communication module; where:

the signal collection module is connected to a testing output port of the to-be-tested target through a data communication cable; and a form of collecting data by the signal collection module corresponds to a form of outputting by the testing output port of the to-be-tested target, and includes collecting a data outputted by the testing output port of the to-be-tested target via an image, a photoelectric system or an analog-digital conversion system;

the signal collection module is further connected to the control module; the signal collection module is configured to obtain the self-test data and/or the test data, and send the self-test data and/or the test data to the control module; where the self-test data and/or the test data includes an original testing code string of a test signal of the to-be-tested target or another format converted from the original testing code string; and

the control module is connected with the communication module; and the control module is configured to identify the fault information from the original testing code string of the testing signal of the to-be-tested target or another format converted from the original testing code string inputted from the signal collection module, generate the fault diagnosis result, and send the fault diagnosis result via the communication module.

Optionally, in the aforementioned system, the system for device fault detection further includes a summarizing apparatus, where:

the summarizing apparatus is connected to multiple apparatuses for fault detection and communicates with the terminal device; and the terminal device receives the fault diagnosis result sent by the multiple apparatuses for fault detection, and sends the fault diagnosis results to the terminal device after summarizing.

Optionally, in the aforementioned system, the system for device fault detection further includes a cascading apparatus and a summarizing apparatus; where:

the cascading apparatus is connected to multiple apparatuses for fault detection and the summarizing apparatus, and the cascading apparatus receives the fault diagnosis result sent by the multiple apparatuses for fault detection and send the fault diagnosis result to the summarizing apparatus; and

the summarizing apparatus is connected with multiple cascading apparatuses and communicates with at least one terminal device, and sends fault diagnosis result to the terminal device after summarizing.

Optionally, in the aforementioned system, the summarizing apparatus includes a signal output module, where the signal output module includes a wireless communication module and a positioning module;

the positioning module is configured to acquire geographic location information of the to-be-tested target and geographic location information of the terminal device; and

the wireless communication module is provided with an IOT (Internet of Things) level SIM card, and transmits, via the IOT level SIM card, the fault diagnosis result and the geographic location information to the terminal device provided with a corresponding SIM card.

Optionally, in the aforementioned system, the apparatus for fault detection is installed inside the to-be-tested target in any of following manners and operates independently from the to-be-tested target;

the apparatus for fault detection is installed inside the to-be-tested target independently;

the apparatus for fault detection is embedded in a relevant main control board of the to-be-tested target; or

the apparatus for fault detection is inserted in a slot of a relevant main control board of the to-be-tested target;

where the apparatus for fault detection includes a signal collection module, a control module and a communication module;

the signal collection module is connected to a testing output port of a main control board of the to-be-tested target by via a dedicated data cable, a module contact or a printed circuit; the signal collection module is further connects to the control module; the signal collection module is configured to obtain the self-test data and/or the test data and send the self-test data and/or the test data to the control module; where the self-test data and/or the test data includes an original testing code string of the testing signal of the to-be-tested target; and

the control module is connected to the communication module, configured to identify the fault information from the original testing code string of the testing signal of the to-be-tested target inputted from the signal collection module, and generate the fault diagnosis result and send the fault diagnosis result via the communication module.

Optionally, in the aforementioned system, the communication module includes a positioning module and a wireless communication module, where:

the positioning module is configured to obtain geographic location information of the to-be-tested target and geographic location information of the terminal device;

the wireless communication module is provided with an IOT level SIM card, and transmit, through the IOT level SIM card, the fault diagnosis result and the geographic location information to the terminal device provided with a corresponding SIM card.

Optionally, in the aforementioned system, in a case that the system for device fault detection includes multiple independent apparatus for fault detection, the system for device fault detection establishes a cluster management mechanism according to a complexity degree, a volume, and a quantity of the to-be-tested target, so as to cascade and summarize the multiple independent apparatuses for fault detection.

Optionally, in the aforementioned system, the system for device fault detection further includes a power source interface module. The power source interface module is integrated on the apparatus for fault detection, and is configured to receive direct current power supply provided by the to-be-tested target or receive direct current power source provided by an independent power source, where the independent power source is independent from the to-be-tested target.

Optionally, in the aforementioned system, the control module includes a processing submodule and an inventory comparison submodule, where:

the processing submodule is connected to the signal collection module, configured to process the original testing code string inputted from the signal collection module, and determine an error information or an error log of the to-be-tested target;

the inventory comparison submodule is connected to the processing submodule, configured to compare the error information or the error log with configuration information stored in a target database of the to-be-tested target after update, and obtain an accurate fault diagnosis result, where the accurate fault diagnosis result includes a location, a type, a standard or a version of a minimum unit which is replaceable on site, of the to-be-tested target after update.

An apparatus for fault defection is further provided according to the present disclosure. The apparatus for fault detection includes a signal collection module, a control module and a communication module; where:

the signal collection module is connected to a testing output port of the to-be-tested target, the signal collection module is further connected to the control module, the signal collection module is configured to obtain a self-test data and/or a test data and send the self-test data and/or the test data to the control module, where the self-test data and/or the test data includes an original testing code string of a testing signal of the to-be-tested target, or another format converted from the original testing code string;

the control module is connected to the communication module, and is configured to identify fault information from the original testing code string of the testing signal of the to-be-tested target or the another format converted from the original testing code string, inputted from the signal collection module, and generate a fault diagnosis result and send the fault diagnosis result via the communication module to a terminal device.

In an embodiment of the present disclosure, with the external apparatus for fault detection operating independently from the to-be-tested target, the self-test information and/or the tested information of the to-be-tested target are collected and converted in signal, and fault detection is performed on the to-be-tested target. Addressed is the technical issue that fault detection and fault alarm for a conventional device can only be “online” and “manual”. In an embodiment of the present disclosure, a self-test signal can be obtained directly via the internal apparatus for fault detection of the to-be-tested target that is embedded in a preset circuit board, which avoids signal conversion, and achieves an object of optimizing the performance of the system for hardware fault detection. Thereby, addressed is the technology issue that the fault detection alarm system has a great limitation and a waste of conversion resources, which is caused by a passive detection method adopted by a conventional system for fault detection and fault alarm performing fault detection on hardware of the device. Thereby, the technical effect of active fault detection on the to-be-tested target is achieved.

### BRIEF DESCRIPTION OF THE DRAWING

For clearer illustration of the technical solutions according to embodiments of the present disclosure or conventional techniques, hereinafter are briefly described the drawings to be applied in embodiments of the present disclosure or conventional techniques. Apparently, the drawings in the following descriptions are only some embodiments of the present disclosure, and other drawings may be obtained by those skilled in the art based on the drawings without creative efforts.

FIG. 1 is a first schematic diagram of a system for device fault detection according to an embodiment of the present disclosure;

FIG. 2 is a second schematic diagram of a system for device fault detection according to an the embodiment of the present disclosure;

FIG. 3 is a first schematic diagram of an application environment for a system for device fault detection according to an embodiment of the present disclosure; and

FIG. 4 is a second schematic diagram of an application environment for a system for device fault detection according to an embodiment of the present disclosure.

### DESCRIPTION OF EMBODIMENTS

Hereinafter the technical solutions according to the embodiments of the present disclosure is described clearly and completely in conjunction with the drawings in the embodiments of the present disclosure. It is apparent that the described embodiments are only a part of the embodiments according to the present disclosure, rather than all the embodiments. Any other embodiments obtained by those skilled in the art based on the embodiments in the present disclosure without any creative efforts fall within the protection scope of the present disclosure.

In the description of the present disclosure, it should be pointed out that, terms “install”, “link” and “connect” should be understood broadly. For example, it can be fixed or detachable or integrated, mechanical or electrical, directly or indirectly through intermediate media, or connected internally by two components. For the person skilled in the art, the terms in the present disclosure can be understood according to the specific situation.

A system for device fault detection is provided according to an embodiment. The system for device fault detection includes an apparatus for fault detection and a terminal device. The apparatus for fault detection operates independently from the to-be-tested target.

The apparatus for fault detection is configured to collect a self-test data and/or a test data of the to-be-tested target, identify fault information of the self-test data and/or the test data, generate a fault diagnosis result according to the fault information, and send the fault diagnosis result to the terminal device.

With the apparatus for fault detection, the system for device fault detection can perform an offline fault diagnosis on a physical layer of the to-be-tested target, and acquire an offline fault diagnosis result automatically based on the self-test data and/or the test data, in a case that the to-be-tested target is in a state of machine-halt or network disconnection.

Optionally, in the embodiment, the system for device fault detection performs fault detection on target hardware and target software in the physical layer of the to-be-tested target, based on an operating system and application software of the system for device fault detection. The target software includes at least one of initial startup software of the to-be-tested target, or testing software of the to-be-tested target. The system for device fault detection further includes a data processing apparatus. The data processing apparatus is configured to integrate the offline fault diagnosis result into an online fault diagnosis result. The online fault diagnosis result is a fault diagnosis result obtained in a case that the system for device fault detection performs an online fault diagnosis on a system layer and an application layer of the to-be-tested target.

The terminal device is configured to receive and display the fault diagnosis result, and communicate with the to-be-tested target. Thereby, a user may view the fault diagnosis result via the terminal device further configured to communicate with the to-be-tested target. The terminal device may further be configured to activate a logistics distribution system for spare components.

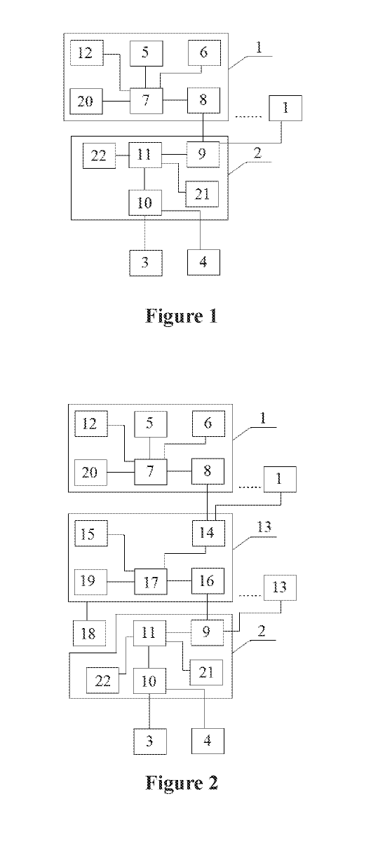

Optionally, reference is made to FIG. 1. In an implementation of the embodiment, the apparatus 1 for fault detection is arranged independently outside the to-be-tested target, and includes a signal collection module 5, a first control module 7 and a first communication module 8.

The signal collection module 5 is connected to a testing output port of the to-be-tested target via a data communication cable. A form for collecting data by the signal collection module 5 is corresponding to a form for outputting data by the testing output port of the to-be-tested target, and includes collecting a data of the testing output port of the to-be-tested target through an image, a photoelectric system or an analog-digital conversion system.

The signal collection module 5 is further connected to the first control module 7. The signal collection module 5 is configured to obtain the self-test data and/or the test data and send the self-test data and/or the test data to the first control module. The self-test data and/or the test data includes an original testing code string of a testing signal of the to-be-tested target or another format converted from the original testing code string.

The first control module 7 is connected with the first communication module 8. The first control module 7 is configured to identify the fault information from the original testing code string of the testing signal of the to-be-tested target or the another format converted from the original testing code string, inputted from the signal collection module, generate the fault diagnosis result, and send the fault diagnosis result via the first communication module 8.

Optionally, in the embodiment, the apparatus 1 for fault detection further includes a data storage module 6. The first control module 7 (a script including all instructions relevant to fault detection) runs, automatically and periodically, the self-test and/or test data of each device collected by the collection module to perform fault detection, and filters out normal operation information (which is not used). In a case that an error information is detected (namely, an error is found in reading an error log or relevant information), the error information is preserved and compared with parts information base in the data storage module 6. Then, it is controlled to output a synthetic signal, of a serial-number information of a corresponding device and a type of a fault part, to the terminal device 3 via the first communication module 8. The self-test data and the test data include a character signal (for example, of a COM port or a network port), an analog signal (for example, of a VGA port or a USB port), an image signal (for example, of an indicator light or a LCD screen), etc.

Optionally, the apparatus 1 for fault detection further includes a data conversion module 12. The data conversion module 12 may convert (through technology such as image recognition, photoelectric sensing, analog-digital conversion, OCR, CCD, and OTG) an image signal or an analog signal in the self-test data and/or the test data into a character signal (in a specific implementation, a photoelectric sensor or a micro camera may be used to capture an arrangement or a combination of the indicator lights; a micro camera may be used to detect and record an error code on a LCD screen by moving; or an input flat cable is externally connected to a pluggable testing module and a data signal thereof is transmitted to the apparatus 1 for fault detection; and then a digital signal is generated via the above technology or by directly acquiring the self-test code of a manufacturer) for the first control module 7 to collect, operate, and perform fault detection.

Optionally, in the embodiment, reference is further made to FIG. 1 again. The system for device fault detection includes a summarizing apparatus 2.

The summarizing apparatus 2 is connected to multiple apparatuses 1 for fault detection, and communicates with the terminal device 3. The summarizing apparatus 2 receives the fault diagnosis results sent by the multiple apparatuses 1 for fault detection, and sends the fault diagnosis results to the terminal device 3 after summarizing. The terminal device 3 includes a laptop, a display, a mobile phone, an IPAD, a multi-screen wall, a personnel scheduling system or a logistics distribution system.

Optionally, in the embodiment, the summarizing apparatus 2 may include a second control module 11, a second communication module 9 and a display output module 10.

The second control module 11 collects, via the second communication module 9, a synthetic signal (including serial-number information of apparatus 1 for fault detection) outputted by each apparatus 1 for fault detection, and sends, via the display output module 10, the synthetic signal to the terminal device 3 for display (which may via ports such as a USB port, a VGA port, a LVDS port, a HDMI port, a network port, a Bluetooth port, and a infrared port).

Optionally, in the embodiment, the apparatus 1 for fault detection further includes a first alarm 20. In a case that the error information is detected, the first control module 7 triggers the first alarm 20 to give an alarm (including a sound, an image, or starting an emergency system).

Optionally, in the embodiment, the system further includes a second alarm 4. The second alarm 4 is connected to the summarizing apparatus 2. The summarizing apparatus 2 triggers the second alarm 4 to give an alarm, on receiving the fault diagnosis.

Optionally, reference is made to FIG. 2. In the embodiment, the system for device fault detection further includes a cascading apparatus 13.

The cascading apparatus 13 is connected to multiple apparatuses 1 for fault detection, and is connected to the summarizing apparatus 2. The cascading apparatus 13 receives the fault diagnosis results sent by the multiple apparatuses 1 for fault detection and sends the fault diagnosis results to the summarizing apparatus 2.

The summarizing apparatus 2 is connected to multiple cascading apparatuses, communicates with at least one terminal device 3, and sends the fault diagnosis results to the terminal device 3 after summarizing.

The cascading apparatus 13 includes a third communication module 14, a data caching module 15, a fourth communication module 16 and a third control module 17. The third control module 17 collects a synthetic signal (including the serial-number information of apparatus 1 for fault detection) outputted from each apparatus 1 for fault detection via the third communication module 14, and stores the synthetic signal in the data cache module 15 for caching. After data collection, the third control module 17 sends the synthetic signal output from each apparatus 1 for fault detection (including the serial-number information of apparatus 1 for fault detection) and serial information of the cascading apparatus 13, via the fourth communication module 16 to the second communication module 9 of the summarizing device 2.

Optionally, in the embodiment, the summarizing apparatus 13 includes k levels. The cascading apparatus 13 of (j+1)th level is connected with the cascading apparatus 13 of jth level in a one-to-one or one-to-many manner. The cascading apparatus 13 of first level is connected with the apparatus 1 for fault detection in a one-to-one or one-to-many manner. The cascading apparatus 13 of kth level is connected with the summarizing apparatus 2, respectively. One apparatus 1 for fault detection is connected with m computers or m servers, respectively. 1≤m≤15, 1≤k, 0≤j≤k to 1.

Optionally, in the embodiment, one cascading apparatus 13 is connected to n apparatuses 1 for fault detection. 1≤n≤20. One summarizing apparatus 2 is connected to z cascading apparatuses 13. 1≤z≤48.

Optionally, in the embodiment, the system for device fault detection further includes a power source 18. The power source 18 is connected to the cascading apparatus 13. The cascading apparatus 13 is connected to the apparatus 1 for fault detection and the summarizing apparatus 2, respectively, via an optical fiber or a net cable. The apparatus 1 for fault detection and the summarizing apparatus 2 acquire power supply from the cascading apparatus via a net cable, or acquire power supply from the independent power source 18.

Optionally, in the embodiment, the cascading apparatus 13 further includes a signal amplifying circuit 19.

The third control module 17 collects, via the third communication module 14, the synthetic signal (including the serial-number information of apparatus 1 for fault detection) outputted from those apparatuses 1 for fault detection, and stores the synthetic signal in the data cache module 15 for caching after amplifying the signal by the signal amplifying circuit 19.

Optionally, in the embodiment, the summarizing apparatus 2 includes a wireless communication module and a positioning module.

The positioning module is configured to obtain geographic location information of the to-be-tested target and geographic location information of the terminal device.

The wireless communication module is provided with an IOT level SIM card. The fault diagnosis result and the geographic location information are transmitted, via the IOT level SIM card, to the terminal device provided with a corresponding SIM card.

The wireless communication module may be a 3G, 4G or 5G module. The positioning module may be a GPS module. The second control module 11 positions a maintenance location and maintenance personnel through the positioning module, and send the synthetic signal outputted from each apparatus 1 for fault detection and the amplified signal of the cascading apparatus 13 via the wireless communication module to the mobile phone of nearby maintenance personnel.

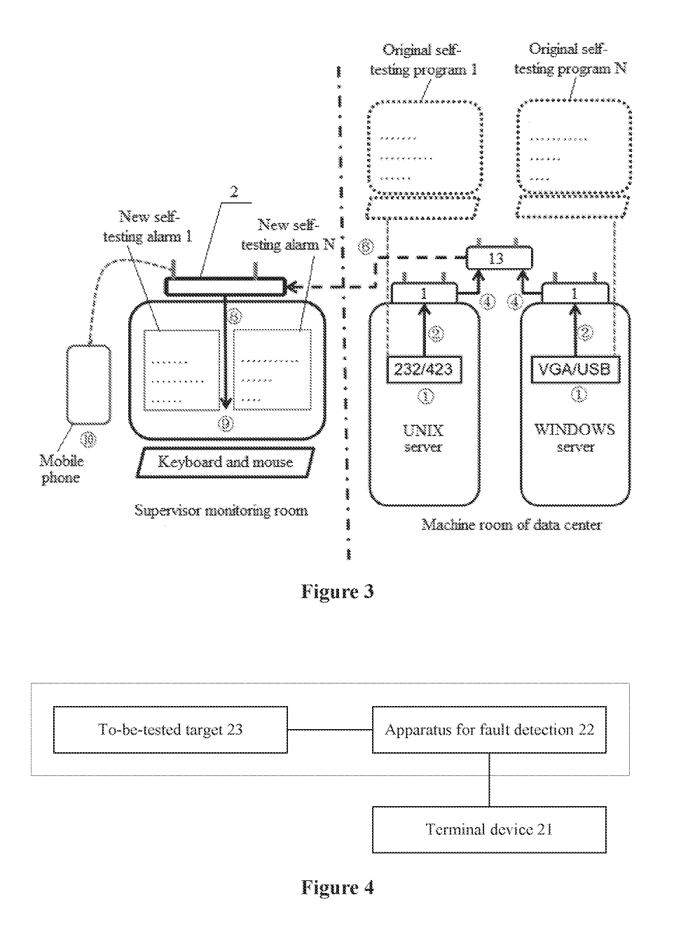

Reference is made to FIG. 3, which is a schematic diagram of an application scene of a system for device fault detection. As shown in FIG. 1 to FIG. 3, in particular, FIG. 3 a schematic diagram in which two to-be-tested targets are arranged. In FIG. 3, \textcircled{1} is a port (such as a COM port), \textcircled{2} is a port line (such as a COM line), \textcircled{4} is an optical fiber, a net cable or wireless connection, \textcircled{6} is an optical fiber, a net cable or wireless connection, \textcircled{8} is a signal output line or wireless connection, \textcircled{9} is a display device, \textcircled{10} is a mobile device, and \textcircled{9} and \textcircled{10} are the terminal device 3 in the present disclosure. The “original testing program 1 and N” in the dashed boxes, for a schematic diagram of computers, is an effect in case of the display being directly connected to a host machine before the present disclosure. In FIG. 3, the dot-dash line in the middle represents a border between a device room and a supervisor monitoring room, which may be a partition wall.

Based on the above design, the system for device fault detection provided by the embodiment can obtains the character signal via the COM port or the network port, obtains the analog signal via the VGA port or the USB port, or obtains the image signal via the indicator lights or the LCD screens. Then, the self-test data and/or the test data is inputted into the apparatus 1 for fault detection. The self-test data and/or the test data is inputted into a cascading apparatus 13 of a next level via operation of each module (the image signal or the analog signal thereof is converted into the character signal (which may adopt technology of image recognition, photoelectric sensing, modulus conversion, OCR, CCD, OTG), and in a specific implementation: a photoelectric sensor or a micro camera may be used to capture an arrangement and a combination of the indicator lights, the micro camera may be used to detect and record an error code of the LCD screen in moving, or, an input flat cable is connected to a pluggable detection module and a data signal thereof is transmitted to the apparatus 1 for fault detection; then the digital signal is generated via the above technology or by directly obtaining a self-test code from the manufacturer). Then, the self-test data and/or the test data is finally connected to the summarizing apparatus 2 outside the device room via a fiber, a twisted-pair cable, a wireless network, or the like, via the operation of each module. Afterwards, the self-test data and/or the test data is connected via the summarizing apparatus 2 to the terminal device 3 (such as a large screen, a monitor, a laptop, an iPad, a mobile phone) for display. In a case that a device supervisor receives an alarm signal (which may be a flashing light or a ringing alarm bell), a displaying page may automatically jump to the abnormal device, and the page display a fault point (such as a CPU, a memory or a fan). In such case, the wireless network may not be used tor safety, and a short message may be sent to a mobile phone of relevant staff of a technology provider or a spare-part supplier. An engineer can fetch a corresponding spare part, according to a reported type, to the user's site for replacement and maintenance, which improves accuracy of repair. In a case that the system is powered and properly encrypted, the engineer may log into the alarmed device via the monitor or a mobile terminal, and enter a command to confirm the diagnosis again, or directly perform remote repair (at this time, the system is not started). In a case that a personnel scheduling system and a logistics distribution system are provided, the user may automatically obtain technical support and spare components delivery service.

The apparatus 1 for fault detection can be designed and manufactured as an ARM embedded printing integrated circuit, which is provided with a processor, a memory, the power supply 18, and a wireless module that are built in, and fixed in a small square box. Or, it can be made into a cabinet with a height of 1U on a standard rack. A front side of the small square box or the cabinet with the height of 1U is provided with an input port and an indicator light. A rear side is provided with an output port and an indicator light (or, the front side is provided with the lights, and the rear side is provided with the ports). Various interfaces corresponding to set-top boxes include a port for power source 18, an Ethernet port, an optical fiber port, a COM port, a USB port, a VGA port, a HDMI port, an audio port, a video port, a printing port, or the like. The power source 18 may be acquired by transforming on site or acquired remotely via a network cable.

In particular, the apparatus 1 for fault detection in the present disclosure may be an embedded industrial computer based on ARM architecture. A front side of the apparatus 1 for fault detection may be provided multiple serial port inputs, a chip may be provided inside for storing and computing, and all relevant commands that the engineers should input are built as “script” programs and implanted into the “apparatus 1 for fault detection” to run automatically in a time-sharing manner (such as running once every 3 minutes). In a case that the apparatus reads the error log or the relevant information and discover a fault, the alarm apparatus is activated. Then, a parts information database which is stored (when the user purchases a machine, the manufacturer has given types and specifications of the parts to the user, and the user can input them into the database) is compared with. Information is outputted, via three-network ports (twisted pair cable, optical fiber, wireless WIFI) at a rear side and according to an requirement, to the cascading apparatus 13 (an input end thereof is multiple ports, and an output end therefore is a single port) or directly to the summarizing apparatus 2 (an input thereof is multiple ports, and an output end thereof is multiple display port, such as a USB port, a VGA port, an LVDS port, an HDMI port), and then outputted via the video line to the terminal device 3, such as a display, a large screen and a laptop, or to a mobile terminal and interacted with an iPad, a mobile phone, or the like. A part number is displayed in a manner of a signal light, a short message, or an image, and is accompanied with a warning sound, so that an user can manage and control the device at any moment.

One to fifteen devices on a same rack may be connected to the same apparatus 1 for fault detection. Such 1U cabinet is loaded into a gap or onto a top of machines on the rack. COM ports of each machine are connected to a port of the apparatus 1 for fault detection. One to twenty apparatuses 1 for fault detection on different racks may be connected via a net cable to the cascading apparatus 13. In a case that a quantity of the racks is large, multiple cascading apparatuses 13 may be connected to form a pyramid-type exchanged connection. A quantity of machines that can be controlled by the whole system for device fault detection in the present disclosure may not be limited, and theoretically, range from 1 to tens of thousands.

Optionally, in another implementation-of the embodiment, the apparatus for fault detection may be installed inside the to-be-tested target in any of the following manners, and operates independently from the to-be-tested target.

The apparatus for fault detection is independently installed inside the to-be-tested target.

The apparatus for fault detection is embedded in a relevant main control board of the to-be-tested target.

The apparatus for fault detection is inserted into a slot of a relevant main control board of the to-be-tested target.

Reference is made to FIG. 4, where the apparatus 22 for fault detection includes a signal collection module, a first control module and a first communication module.

The signal collection module is connected, via a dedicated data cable, a module contact or a printed circuit, to a testing output port of a main control board of the to-be-tested target 23. The signal collection module is further connected to the first control module. The signal collection module is configured to obtain a self-test data and/or a test data of the to-be-tested target 23, and send the self-test data and/or the test data to the first control module. The self-test data and/or the test data include an original testing code string of a testing signal of the to-be-tested target 23.

The first control module is connected to the first communication module. The first control module is configured to identify fault information from the original testing code string of the testing signal of the to-be-tested target 23 inputted from the signal collection module, and generate a fault diagnosis result and then send the fault diagnosis result via the first communication module.

Optionally, in the embodiment, the apparatus 22 for fault detection is a circuit board that integrated with multiple modules. Testing software configured to perform fault detection on the to-be-tested target 23 is embedded in the first control module. The apparatus 22 for fault detection is mainly configured to obtain self-test information and/or test information of the to-be-tested target 23, then process the self-test information and/or the tested information to obtain the fault diagnosis result, and send the fault diagnosis result to a client APP of the terminal device 21 for alarm and display.

Optionally, in the embodiment, the terminal device 21 is provided with the client APP. The terminal device 21 is configured to transmit, via the client APP to the system for device fault detection, at least one of the following information: a machine number of the to-be-tested target 23, IP address information, prompt message information, a threshold of error level, a card number of a SIM card installed in the terminal device 21, or a program and/or a keyword that is changed in the system for device fault detection.

The terminal device 21 provided with the client APP is further configured to send a query instruction and a recheck instruction to the system for device fault detection. The query instruction is configured to query a history fault diagnosis result. The recheck instruction is configured to re-check and repair the fault device in a simple manner.

It should be noted that, in the embodiment, the client APP is installed in the terminal device 21, and the client APP is connected in pair with the apparatus 22 for fault detection. Namely, the client APP is a client compatible with the system for device fault detection. In a case that a user uses the system for device fault detection to perform fault detection on the to-be-tested target 23, the client application may be installed in the terminal device 21, and then a communication connection between the client and the apparatus 22 for fault detection may be established. In such case, the apparatus 22 for fault detection can send the fault diagnosis result to the terminal device 21 in real time for display and alarm.

It should be further noted that, when the manufacturer of to-be-tested target 23 manufactures the to-be-tested target 23, the apparatus 22 for fault detection according to an embodiment of the present disclosure may be integrated on the main control board of the to-be-tested target 23, and a terminal device 21 which is compatible may be provided. The client APP is installed in the terminal device 21. In such case, the user can monitor an operating status of the to-be-tested target 23 in real time via the terminal device 21. Optionally, the manufacturer of target 23 may not provide the terminal device 21, and may provide an application of the client APP. The user may install the application in any terminal device 21, and establish a connection in pair with the apparatus 22 for fault detection.

In the embodiment, the apparatus 22 for fault detection may be independently installed inside the to-be-tested target 23, embedded in the relevant main control board of the to-be-tested target 23, or inserted in the slot of the relevant main control board of the to-be-tested target 23. By installing the apparatus 22 for fault detection inside the to-be-tested target 23, the apparatus 22 for fault detection can collect the self-test information or the test information before signal converting, so as to optimize a performance of the system for hardware fault detection. Thereby, alleviated is the technology problem that a passive testing manner adopted by a conventional system for device fault detection when performs fault detection on the to-be-tested target results in large limitations and a waste of conversion resources. Thereby, a technical effect of active fault detection for the to-be-tested target 23 is achieved.

The system for device fault detection in the conventional technology can achieve the online fault diagnosis for the to-be-tested target 23. Namely, the fault detection is performed in a case that the to-be-tested target 23 is not powered off or halted. In a case that the to-be-tested target 23 is powered off or halted, the fault detection cannot be performed on the to-be-tested target. For the above disadvantages, the embedded intelligent system for device fault detection according to an embodiment of the present disclosure can perform offline fault diagnosis on a physical layer of the to-be-tested target 23 in a case that the to-be-tested target 23 is halted or powered off, and obtain an offline fault diagnosis result. Thereby, the technical issue that the conventional system for device fault detection cannot perform offline fault diagnosis for to-be-tested target 23 is addressed.

In particular, in the embodiment, the system for device fault detection can perform fault detection on target hardware and target software of the physical layer of the to-be-tested target 23 based on an operating system and application software of the system, in case of performing the offline fault diagnosis on the physical layer of the to-be-tested target 23. The target software includes at least one of: initial startup software of the to-be-tested target 23, or testing software of the to-be-tested target 23.

It should be noted out that, in the embodiment, apart from performing the offline fault diagnosis on the to-be-tested target 23, the system for device fault detection may further perform online fault diagnosis on an application layer of the to-be-tested target 23, and obtain an online fault diagnosis result. After the offline fault diagnosis result and the online fault diagnosis results of the terminal device 21 are obtained, the offline fault diagnosis result and online fault diagnosis result may be merged. A result after merge is displayed and monitored.

For example, after performing fault diagnosis on the physical layer of to-be-tested target 23, the obtained offline fault diagnosis result is: a component of model A1, version B1, specification C1 and location D1 fails. After performing fault diagnosis on the application layer of to-be-tested target 23, the obtained online fault diagnosis result is: a component of model A1 or A2, version B1 or B2, specification C1 or C2, and location D1 or D2 fails. The component refers to a minimum replaceable unit in the to-be-tested target 23. In such case, the terminal device 21 may merge the two fault diagnosis results, for example, display the offline fault diagnosis result at left of a window which is configured to display the fault diagnosis result in the client APP, and display the online fault diagnosis result at right of the window, which is configured to display the fault diagnosis result in the client APP. By comparing the offline fault diagnosis result with the online fault diagnosis result on a same screen, more precise fault information can be provided to users, serving as double assurance. In a case that the to-be-tested target 23 is halted or powered off, a location, a model, a specification, a version and other information of the fault can be determined from the offline fault diagnosis result. Further, in a case that a personnel dispatch system and a logistics distribution system are provided, users may automatically obtain technical support and spare components delivery service.

Optionally, in the embodiment, in a case that the system for device fault detection includes multiple independent apparatuses 22 for fault detection, the system for device fault detection may establish a cluster management mechanism according to a complexity degree, a volume, and a quantity of the to-be-tested target 23, so as to cascade and summarize the multiple independent apparatuses 22 for fault detection.

Optionally, in the embodiment, the to-be-tested target 23 includes an electromechanical device with a self-testing function. The electromechanical device includes: a computer, a robot, mechanical equipment, medical equipment, a household appliance, and a mobile vehicle of water, land or air.

In particular, the system for device fault detection can be configured for high-end hardware maintenance fields of all industries. As long as the to-be-tested target 23 is equipped with testing means such as self-test, logs and diagnostic command set, the apparatus 22 for fault detection on hardware according to an embodiment of the present disclosure can be applied to perform fault alarm. For example, a core “computer” part of, for example, a household appliance or an aircraft, is an apparatus 22 for fault detection, of a computer or an industrial personal computer. Thereby, all of the above can use the apparatus for hardware fault defection according to the embodiment of the present disclosure, to perform fault alarm.

Hereinafter some examples are illustrated.

First, for an airborne vehicle, such as an airplane. Because there are a lot of instrument panels in a cockpit of the airplane, it is necessary tor a pilot to manually see the panels clearly, react accurately, and determine accurately in real time. It is not easy for the pilot to manually see clearly, react accurately, and determine accurately in real time. And, ground staff cannot learn operating states of aircraft machinery and an aircraft electrical appliance in real time.

In the embodiment, the system for device fault detection can be installed inside the main control apparatus of the aircraft. In case of any fault, multiple alarms can be reported automatically and timely. The alarm signal can be transmitted to the pilot, a “black box” and relevant ground staff in the control tower unerringly, without losing any instantaneous testing information of the to-be-tested target 23 due to delay of a transmission distance. In such case, all relevant personnel can spot problems simultaneously, respond to emergencies jointly, and do not have to rush to find the “black box” afterwards. Efficiency of handling risk and the safety assurance are improved.

Second, for a land vehicle, such as a car. In a case that the car is not driven by an owner, the car owners or a rental company who manages the rental often do not know a detailed using situation of the car in real time, based on data displayed and not displayed on the dashboard (such as a tire pressure, a fuel consumption, a speed, a fault lights, and a noise). The system for device fault detection according to the embodiment of the present disclosure can record a fault situation of the car in real time, and feed the fault situation back to the terminal device 21. Thereby, the owner and the rental company who holds the terminal device 21 are able to timely learn about the operating situation of the car.

In a case that the car is driven by the owner, a defect or a hidden trouble of a new car often lead to unnecessary disputes between a driver and a manufacturer or a 4S store. In addition, a cheating behavior in parts replacement at some maintenance pits results in a lot of losses to the owner. By using the system for device fault detection according to the embodiment of the present disclosure, the owner can know the vehicle condition in case of any fault or doubt. No matter whether the owner is professional in technics or not, the owner can know which part has a problem, how to operate, whether it should be repaired, where to repair, how much would be cost, so as to achieve transparent control. For example, driving recorders help a lot for ruling of traffic accidents. Similarly, the system for device fault detection according to the embodiment of the present disclosure can help car owners to quickly identify the vehicle fault.

Third, for a water vehicle, such as a ship. There are also a large number of dashboards in a cockpit of a ship, which also requires a pilot to manually see clearly, react accurately, and determine accurately in real time. In a case that the ship fails, a lot of instrument inspection work brings a heavy workload to the staff. In particular, marine environment is special, where the signal is poor and the spare parts are inadequate. It is necessary to timely and accurately determine a faulty part or a fault point of the ship and then inform relevant staff to repair, so as to save a lot of time for the staff and ensure the personal and property safety of the staff.

Fourth, for a household appliance, such as an air conditioner. In a case that the air conditioner is not cooling, there is generally a fault in the air conditioner. The user cannot know a specific location of the fault, such as a compressor fault, a condenser fault, a valve fault, a fluorine-deficiency fault or other faults. The location of the fault is known, by maintenance personnel, only when the maintenance personnel repair the air conditioner. When maintenance personnel are required to repair the air conditioner, they may sometimes change a lot of things, which costs a lot of money and often causes the users to feel cheated. The system for device fault detection according to the embodiment of the present disclosure can test the air conditioner in real time, and accurately determine the fault location of the air conditioner.

Fifth, for a computer, such as a computer. There are a large number of computers in a computer room of a company. In a case that a large number of computers fail, network management personnel need to inspect the computers one by one. It not only wastes a lot of time for the network management personnel, but also makes the detection speed very low. In a case that the company needs to use the computers, it causes unnecessary trouble. In a case that the system for device fault detection according to the embodiment of the present disclosure is embedded in main cases of the computers, the system for device fault detection can detect a computer fault in real time, identify the fault and obtain a fault diagnosis result. In such case, what the relevant technicians need to do is only to repair the computers according to the fault diagnosis result. Thereby, the system for device fault detection can improve the efficiency of network management personnel repairing computers and save time for the relevant technicians.

Optionally, in the embodiment, a volume of the apparatus 22 for fault detection is less than 12*12*2 cubic centimeters. A shape and a size of the apparatus 22 for fault detection depend on an internal structure, complexity, and a size of an additional function module, of the to-be-tested target 23.

In particular, the apparatus 22 for fault detection may be configured a circuit board having a volume of length*width*height to be 12*12*2 , or the apparatus 22 for fault detection may be configured as a circuit board having a volume less than 12*12*2 cm. Given a limited space of a main control apparatus of the to-be-tested target 23, such as a computer case, a controller of an air conditioner, and a main controller of the car, the apparatus 22 for fault detection in the embodiment of the present disclosure is generally configured as a size of a structure of length*width*height to be 12*12*2 cm. In particular, the size of length*width*height the apparatus 22 for fault detection is not limited to be 12*12*2 cm. An actual size of the apparatus 22 for fault detection may be determined based on the internal space of the to-be-tested target 23, or may be tailored according to different usage requirements, where different modular apparatuses and interfaces are added or removed to minimize occupied resources. In the embodiment, specific length, width and height scales of the apparatus 22 for fault detection are not specifically limited, as long as it can be installed inside the to-be-tested target 23 and meet a functional requirement.

Optionally, in the embodiment, the system for device fault detection further includes a power interface module. The power interface module is integrated on the apparatus 22 for fault detection, and is configured to receive direct current power supplied by the to-be-tested target 23, or configured to receive direct current power source supplied by an independent power source. The independent power source is independent from the to-be-tested target 23.

In particular, in the embodiment, one or multiple power interface modules may be integrated on the apparatus 22 for fault detection. The power source interface modules may be connected to a direct current power source provided by the to-be-tested target 23, so as to acquire direct current power supplied by the to-be-tested target 23. In a case that the to-be-tested target 23 operates normally or is not powered off, the system for device fault detection can perform fault detection normally.

In addition, a direct current power source (for example, 5V, 9V, 12V, 24V, 38V direct current power source) can be independently arranged to prevent that the system for device fault detection cannot operate normally in a case that the to-be-tested target 23 is powered off. A universal 12V direct current power source may be independently arranged inside the to-be-tested target 23, or may be independently arranged outside the to-be-tested target 23.

It should be noted that, in the embodiment, the to-be-tested target 23 may be separately used to supply direct current power for the device fault detection system, the 12V direct current power source may be separately used to supply power to the system for device fault detection, or the to-be-tested target 23 and the 12V direct current power source may be combined to supply power to the system for device fault detection. The direct current power source may be an electric power apparatus, such as a chassis power source, a storage battery, a lithium battery, or an external power source.

In the embodiment, the 12V direct current power source may be connected to a power output port of the to-be-tested target 23, so as to achieve supply power to the 12V direct current power source. For example, the apparatus 22 for fault detection is connected to the terminal device 21 via a twisted pair cable. Two core wires among the 8 core wires in the twisted pair cable may serve as a power cord to supply power reversely from a notebook terminal to the apparatus 22 for fault detection according to the present disclosure.

Optionally, in the embodiment, a testing input port is arranged on the signal collection module. The testing input port is connected via the dedicated data cable, the module contact or the printed circuit to a testing output port of a main control board of the to-be-tested target 23. The testing input port is configured to obtain the self-test data and/or the test data of the to-be-tested target 23 and send the self-test data and/or the test data to the control module. Thereby, the control module determines error information or an error log of the to-be-tested target 23 based on an error level.

Optionally, in the embodiment, the testing input port may be connected to the testing output port of the main control board of to-be-tested target 23. The to-be-tested target 23 outputs a testing signal via the testing output port. The outputted testing signal is an original testing code string. Namely, the testing signal inputted to a signal identification module is not converted and is an original signal. The testing signal includes a self-test signal and a test signal. The self-test signal can be understood as a signal obtained by the to-be-tested target 23 when initiating a self-test program. The test signal is a signal obtained after receiving a testing command and testing the to-be-tested target 23.

According to the above description, the testing signal collected by the signal collection module is the original testing code string. Namely, the testing signal may carry multiple types of programming languages. In such case, the signal collection module processes the testing signal, and the processed testing signal may be recognized by other modules. After processing, the processed testing signal may be sent to the first control module for processing. The first control module may determine the error information or the error log of the to-be-tested target 23 based on the error level, after obtaining the processed testing signal. In the embodiment, error level thresholds generally include thresholds of 1 to 7 levels, primarily. For example, I or “info” represents some basic message description, W or “warn” represents a warning signal and is configured to indicate that the device may have a problem which does not affect normal operation, E or “error” represents some severe error information, and F or “fatal” represents error information that is more severe than “error”. In a case that the error level threshold is set to be the last two levels, it is generally necessary to repair or replace hardware in case of reporting an error.

Optionally, in the embodiment, the first control module includes a processing submodule and an inventory comparison submodule.

The processing submodule is connected to the signal collection module, and is configured to process the original testing code string inputted from the signal collection module, to determine the error information or the error log of the to-be-tested target 23.

The inventory comparison submodule is connected to the processing submodule, and is configured to compare the error information or the error log with configuration information stored in a target database of the updated to-be-tested target 23, to obtain an accurate fault diagnosis result. The fault diagnosis result includes a location, a type, a specification or a version of a minimum replaceable unit on site of the updated to-be-tested target 23.

Optionally, in the embodiment, after analyzing and processing the testing signal and obtaining the error information or the error log, the processing submodule may send the error information or the error log to the inventory comparison submodule. Thereby, the inventory comparison submodule compares the error information or the error log with configuration information stored in the target database, and obtains the fault diagnosis result (including the offline fault diagnosis result and/or the online fault diagnosis result). The obtained fault diagnosis result includes a fault position, and the type, the specification, the version and other information of a part at the fault position.

It should be noted out that, a part of to-be-tested target 23 may be replaced, for example, a type and a size of a memory stick/board/block in a main computer case of a computer may be replaced. The system for device fault detection according to an embodiment of the present disclosure can timely detect replacement of electronic parts in to-be-tested target 23 via special instructions, store information of a part after replacement (such as a type, a version and a specification) in the target database, and obtain an updated target data. In such case, that the inventory comparison submodule makes a comparison may be appreciated as comparing the error information or the error log with the configuration information stored in the target database of the updated to-be-tested target 23, and obtaining the fault diagnosis result.

The first communication module is configured to generate alarm prompt information based on a control signal of the first control module, and continuously transmit the alarm prompt information for n times in succession to the terminal device 21 having an information-receiving function or being provided with a client APP. n is a positive integer greater than 1. The alarm prompt information is stored in a first-in-last-out manner, with a preset times or for a preset time.

It should be noted that, in the embodiment, the alarm prompt information may be stored via a storage device. The storage device is a FIFO memory, namely, the alarm prompt information is stored in the storage device in a first-in-first-out manner. In general, a storing time or a preset storing times can be set. For example, the storing time may be set as 3 days, or the preset storing times may be set as 5 times.

Optionally, in the embodiment, the first communication module may include a positioning module and a wireless communication module;

The positioning module is configured to obtain geographic location information of the to-be-tested target 23 and geographic location information of the terminal device 21.

The wireless communication module is provided with a IOT level SIM card. The fault diagnosis result and the geographic location information are transmitted via the IOT level SIM card to the terminal device 21 provided with a corresponding SIM card.

The wireless communication module includes at least one of: a mobile 3G/4G/5G communication apparatus, a satellite communication apparatus, a WIFI communication apparatus, a cable communication apparatus, or a radio transmission communication apparatus.

The mobile 3G/4G/5G communication apparatus includes a 3G/4G/5G module arranged inside the system for device fault detection. The mobile 3G/4G/5G communication device is provided with the IOT level SIM card, and transmits the fault diagnosis result via the IOT level SIM card to the terminal device 21 provided with a target SIM card.

In particular, in the embodiment, the wireless communication module may be a 3G/4G/5G communication apparatus. The mobile 3G/4G/5G communication apparatus is integrated on the apparatus 22 for fault detection, and a 3G/4G/5G module is arranged inside the mobile 3G/4G/5G communication apparatus. A SIM card can be installed in the mobile 3G/4G/5G communication device, including a normal SIM card or an IOT level SIM card. In a case that the SIM card is the IOT level SIM card, the mobile 3G/4G/5G communication apparatus transmits the fault diagnosis result to the client APP of the terminal device 21 provided with the target SIM card conveniently.

The satellite communication apparatus includes a satellite/GPS/Beidou positioning module and an associated sensor, which are arranged inside the system for device fault detection. The satellite communication apparatus is configured to transmit target information to a target device. The target information includes at least one of: a diagnosis result, or a moving position of the to-be-tested target 23. The target device includes at least one of: the terminal device 21, a monitoring center, or a monitoring storage device.

Optionally, in the embodiment, the wireless communication module may further be selected as the satellite communication apparatus. The satellite communication apparatus is integrated on the apparatus 22 for fault detection. The satellite/GPS/Beidou positioning module and the associate sensor are built in the satellite communication apparatus.

The satellite communication apparatus is configured to transmit the fault diagnosis result to the target device. In addition, the satellite communication apparatus is further configured to transmit the moving position of the to-be-tested target 23 to the target device. The target device includes a terminal device 21 (for example, the aforementioned terminal device 21 provided with the client APP). The target device includes the monitoring center or the monitoring storage device. The monitoring storage device includes an electronic recording device such as a black box and a driving recorder.

In a case that the to-be-tested target 23 is a mobile vehicle, the satellite/GPS/Beidou communication device may further perform positioning and rescue, which includes positioning and rescue for mechanical failure and personnel accident, in real time.

The WIFI communication apparatus includes a WIFI socket arranged inside the system for device fault detection. A MAC address and an identifier of the WIFI socket are bound to the client APP installed in the terminal device 21. The WIFI socket is connected in pair with the client APP.

Optionally, in the embodiment, the WIFI communication device includes a WIFI socket arranged inside the system for device fault detection. The WIFI socket includes a unique MAC address and a unique identifier that can receive or transmit WIFI signals. In such case, the client APP of the terminal device 21 may be bound to the unique MAC address arid the unique identifier of the WIFI socket. Different from the conventional apparatus 22 for fault detection, in the embodiment, terminal device 21 may be connected in pair with the WIFI socket of the apparatus 22 for fault detection via automatic scanning, and may further perform intelligent monitoring for remote transmission via a WeChat service.

The cable communication apparatus may be arranged inside the system for device fault detection. The cable communication apparatus is connected via a target cable to the terminal device 21. The cable communication apparatus is configured to transmit the fault diagnosis result to the terminal device 21, or transmit a direct current obtained from the terminal device 21 reversely to the system for device fault detection, so as to supply power to the system for device fault detection. The target cable includes at least one of: an optical fiber, a twisted pair cable, an USB cable, a VGA cable, a COM cable, or an audio/video output cable.

Optionally, in the embodiment, the wireless communication module may be replaced with a cable communication apparatus. The cable communication apparatus is arranged inside the system for device fault detection and is connected to the terminal device 21. The cable communication apparatus is configured to transmit the fault diagnosis result to the terminal device 21. In addition, the cable communication apparatus may transmit the direct current power obtained from the terminal device 21 via the cable to the system for device fault detection, so as to supply power to the system for device fault detection. The target cable has a variety of types. In the embodiment, the preferable target cable is an optical fiber, a twisted pair cable, a USB cable, a VGA cable, a COM cable, or an audio/video output cable.

The radio transmission communication apparatus is configured to transmit the fault diagnosis result or the fault alarm signal of the to-be-tested target 23 to the terminal device 21 which is provided with a radio receiving apparatus.

Optionally, in the embodiment, the wireless communication module further includes the radio transmission communication apparatus. The radio transmission communication apparatus is integrated on the apparatus 22 for fault detection, and is configured to transmit the fault diagnosis result or the fault alarm signal of the to-be-tested target 23 to the terminal device 21 which is provided with the radio receiving device.

Optionally, in the embodiment, the first control module may further include an instruction operating submodule. The instruction operating submodule is configured to run, via a programming language such as Java/C, a command set script and a software package related to a testing command. The instruction operating submodule is further configured to store the testing instruction, a regularly-read instruction, the error level threshold indicated by the error information or the error log, and initial configuration information. It should be noted that the above instruction operating submodule is configured to store the above instruction and relevant information, and is not limited merely to the above instruction and related information. In the embodiment, all the instruction related to the testing program may be stored in the instruction operating submodule.

Optionally, in the embodiment, the instruction operating submodule includes a read only memory and a read/write memory. The read only memory is configured to store the testing instruction. The read/write memory is configured to store the regularly-read instruction, the error level threshold indicated by the error information, and the initial configuration information.

Optionally, in the embodiment, the testing instruction may be embedded in the read only memory ROM. In a case that the testing instruction needs to be called, the testing instruction may be called from the read only memory ROM for testing. Further, other instructions than the testing instruction may be embedded in the read only memory ROM. The regularly-read instruction, the error level threshold, and the initial configuration information may be embedded in the readable and writable memory RAM. The initial configuration information is initialization information, for example, an initialization command, a machine name, a machine serial number, a type of the terminal device 21, and a related parameter of the related client APP in the terminal device 21.

Optionally, in the embodiment, the terminal device 21 is further configured to send revisions of at least one of the following information, via a display page thereof or a page installed with client APP page, to the apparatus 22 for fault detection; a machine number, IP address information, prompt information, and the threshold of the error level of the to-be-tested target 23, a number of the SIM card installed in the terminal device 21, and a program and/or a keyword changed in the device system for device fault detection. The terminal device 21 stalled with the client APP is further configured to send a search instruction via a network output module to the system for device fault detection. The search instruction is configured to search for a history fault diagnosis result.

In particular, the users may send a search instruction via a display page of the client APP of the terminal device 21 to the system for device fault detection. For example, the user may enter a search date “2016.11.28” in a search filed for fault diagnosis result of the client APP. Then, on receiving the search date, the system for device fault detection searches for the alarm information on the search date, and sends a search result to the client APP of the terminal device 21 for display. Further, the user may enter “2016.11.28, 8:00pm to 16:00pm”, that is, search the alarm prompt information during 8 a.m. to 4 p.m. on 28th, November, 2016. On receiving the search instruction, the system for device fault detection searches, based on the search date inputted by the user, the history alarm prompt information for the alarm prompt information of such time period, and sends the search result to the client APP of the terminal device 21 for display.

Optionally, in the embodiment, the terminal device 21 provided with the client APP further includes an encryption apparatus. The encryption device is bound to the system for device fault detection, and is configured to encrypt the system for device fault detection. The encryption apparatus includes at least one of: a password input apparatus, an image acquisition apparatus, a watchdog apparatus, a fingerprint registration apparatus, a face and voice recognition apparatus, a front-end server, or a two-dimensional code recognition apparatus.

For example, with the fingerprint registration apparatus, in a case that a user clicks to open the client APP installed in the terminal device 21, a display interface of the fingerprint registration apparatus is displayed on a display interface of the terminal device 21, and a fingerprint of the user is recognized. In a case that the identification is positive, an access between the client APP and the apparatus 22 for fault detection is opened. For another example, with the face recognition device, in a case the user clicks to open the client APP installed in the terminal device 21, a display interface of the face recognition device is displayed on the display interface of the terminal device 21, and a face image of the user is identified. In a case that the identification is positive, an access between the client APP and the apparatus 22 for fault detection is opened.

Optionally, in the embodiment, the terminal device 21 is further configured to send the testing instruction via the network communication apparatus to the system for device fault detection, so that the system for device fault detection can perform fault detection on the to-be-tested target 23 based on the testing instruction.

It should be noted that, in an embodiment, a development platform of the client APP is an android platform. The client APP may generate a framework to open an account, establish a basic configuration of an alarm system, establish a port API protocol to the alarm system, and establish an operation page layout. The client APP may further establish an expression corresponding to sentences and animations, translate short message, cut an image with high fidelity, and realize binding with the alarm system. The client APP may further realize man or machine positioning by the GPS module. The client APP may perform a stress test and eliminate a BUG.

Based on the above designs, the system for device fault detection is provided according to the embodiment. The system for device fault detection is independently installed inside the to-be-tested target 23, embedded in the relevant main control board of the to-be-tested target 23, or inserted in the slot of the relevant main control board of to-be-tested target 23. For example, it is embedded inside the computer, and is connected via a testing data line to the main control board of the computer. Hardware of the system for device fault detection may be selected as an embedded printing integrated circuit base on ARM, and may supports a multi-core CPU, a memory of multiple gigabytes, an optional communication apparatus and port, an independent DC power source, and the like. Software may be selected as a platform based on a Linux or Android operating system, and support programming with Java, C and other language. The diagnostic command set is embedded via the aforementioned hardware and software, and the client APP corresponding to the apparatus for fault detection is installed in the terminal device 21, to achieve remote monitoring and management.

Finally, it should be noted that the above embodiments are merely provided for illustrating the technical solutions of the present disclosure and not to limit the present disclosure. Although the present disclosure has been described in detail in reference to the foregoing embodiments, those skilled in the art should appreciate that modification can be made to the technical solutions described in the foregoing embodiments, and equivalent replacement of partial or all the technical features can be made to the foregoing embodiments. The modifications or replacements would not make the essence of the corresponding technical solutions depart from the scope of the technical solutions of the embodiments of the present disclosure.

### INDUSTRIAL APPLICABILITY

The purpose of the present disclosure is to provide a system for device fault detection and an apparatus for fault detection, so as to address a technical issue that a conventional system for fault detection system has a great limitation because it can only use an online detection mode and a passive detection in case of performing fault detection on hardware such as an electromechanical device. The main features are as follows.

First, the present disclosure is generally applicable to large or expensive device (including a computer, a mechanical system, an electronic or electrical device, or the like, which are abbreviated as a device), and may not be applicable to small or inexpensive electronic and mechanical devices that is not suitable for multiple repairs, such as a low-end personal computer, a toy, a household appliance, and so on.

Second, the present disclosure generally adopts the “offline” (system not started) mode displayed after testing commands from the underlying or physical layer are summarized and processed by an original port (similar to a serial port), which is fundamentally different from the conventional “online” (system started) mode based on a system network layer or an application layer. That is, it is an automatic “offline” testing means in a case that the “online” network is interrupted or even down, where it requires manual inspection, and it uses modern intelligent technology to transmit alarm for maintenance. The issue of intelligent automation of device testing can only be addressed when “online” mode is combined with “offline” mode.

Third, the present disclosure is divided into two parts on the basis of the “offline” underlying-layer detection system. For the used (old) device, testing and alarm are achieved via an external-connection manner. For the unused (new) device, the built-in “module device” and “module design” methods are added and applied to detect alarms.

Fourth, the present disclosure further improves an integration degree, thereby saving space and resources, and reducing line faults and a loss in system occupation. The apparatus 22 for fault detection may be embedded in the to-be-tested target 23 when the to-be-tested target 23 is shipped from the factory, which serves the user once and for all, is convenient for management, saves manpower and material cost, and saves a large amount of costs for training senior technicians (where those have general disassembly skills are adequate). Through the alarm system, the manufacturer can correctly analyze a probability for vulnerable parts in order to improve the product, and the maintainer can accurately identify the problem in time and simplify the maintenance operating process. The alarm system supports a bi-directional remote man-machine interaction, to realize a modern intelligent control manner based on the Internet. The alarm system supports the personnel scheduling system and the logistics distribution system, and may automatically receive technical support and spare parts supply. The alarm system is directly connected to the to-be-tested target, which can reduce intermediate links, unify code outputting standards, and is simple and smart.

Fifth, the alarm system provided by the embodiment of the present disclosure may be installed in a new generation of devices, to add new selling points. The alarm system may be extended to all industries, reform and subvert a traditional maintenance mode of all electromechanical devices, and make hardware maintenance simpler, more realistic and more interesting (for example, using an vivid animation in the APP).

1-20. (canceled)

21. An apparatus for fault detection, comprising a memory and a processor, wherein the memory stores instructions, and the instructions when executed by the processor configure the apparatus for fault detection to:
collect a self-test data and/or a test data of a to-be-tested target;
perform, based on the self-test data and/or the test data, offline fault diagnosis on a physical layer of the to-be-tested target, in a case the to-be-tested target is in a state of machine-halt or network disconnection, wherein fault information is recognized from the self-test data and/or the test data in the offline fault diagnosis;
generate, based on the fault information, an offline fault diagnosis result, through an algorithm;
send the offline fault diagnosis result to a terminal device; and
instruct the terminal device to display the offline fault diagnosis result to a user; wherein the terminal device communicates with the to-be-tested target.

22. The apparatus for fault detection according to claim 21, wherein the apparatus for fault detection is powered by the terminal device via a cable, or powered by the to-be-tested target via a cable, or by an independent power source.

23. The apparatus for fault detection according to claim 21, wherein the self-test data is generated by a program that is in the physical layer and automatically detects a hardware fault, and the test data is generated by inputting a command to test a hardware fault.

24. The apparatus for fault detection according to claim 21, wherein:
the offline fault diagnosis is performed on target hardware and target software in the physical layer of the to-be-tested target;
the target software comprises initial startup software of the to-be-tested target, or testing software of the to-be-tested target.

25. The apparatus for fault detection according to claim 21, wherein the instructions when executed by the processor further configure the apparatus to:
perform online fault diagnosis on a system layer and an application layer on the to-be-tested target, to acquire an online fault diagnosis result;
merge the offline fault diagnosis result into the online fault diagnosis result, to acquire a merged fault diagnosis result;
send the merged fault diagnosis result to the terminal device; and
instruct the terminal device to display the merged fault diagnosis result.

26. The apparatus for fault detection according to claim 21, wherein collecting the self-test data and/or the test data of the to-be-tested target comprises:
collecting the self-test data and/or the test data via a data communication cable, a module contact, or a printed circuit, which is connected to a testing output port of the to-be tested target;
wherein the self-test data and/or the test data is collected via an image, a photo-electrical system, or an analogy-digital conversion system from the testing output port.

27. The apparatus for fault detection according to claim 21, wherein the self-test data and/or the test data of the to-be-tested target comprises an original testing code string of a testing signal from the to-be-tested target, or another format converted from the original testing code string.

28. The apparatus for fault detection according to claim 21, wherein the self-test data and the test data each is converted into a character signal after being received by the apparatus for fault detection.

29. The apparatus for fault detection according to claim 21, wherein the instructions when executed by the processor further configure the apparatus to:
process the self-test data and/or the test data of the to-be-tested target, to determine error information or an error log of the to-be-tested target and distinguish an error level; and
compare the error information or the error log with configuration information stored in a target database for the to-be-tested target, to acquire an accurate fault diagnosis result;
wherein the accurate fault diagnosis result comprises a position, a type, a specification, or a version of a minimum component that is replaceable on site.

30. A system for device fault detection, comprising one or more apparatuses for fault detection, wherein each of the one or more apparatuses for fault detection is the apparatus for fault detection according to claim 21.

31. The system for device fault detection according to claim 30, further comprising a summarizing apparatus, wherein:
the one or more apparatuses for fault detection is a plurality of apparatuses for fault detection;
the summarizing apparatus is connected to the plurality of apparatuses for fault detection, and communicates with the terminal device; and
the summarizing apparatus receives and summarizes the offline fault diagnosis result sent by each of the plurality of apparatuses for fault detection, and sends the summarized offline fault diagnosis result to the terminal device.

32. The system for device fault detection according to claim 30, further comprising a plurality of cascading apparatuses and a summarizing apparatus, wherein:
the one or more apparatuses for fault detection is a plurality of apparatuses for fault detection;
the plurality of cascading apparatuses is connected to the plurality of apparatuses for fault detection, and connected to the summarizing apparatus;
the plurality of cascading apparatuses receives the offline fault diagnosis result sent by each of the plurality of apparatuses for fault detection, and send the offline fault diagnosis result to the summarizing apparatus; and
the summarizing apparatus summarizes the offline fault diagnosis result sent by the plurality of cascading apparatuses, and sends the summarized offline fault diagnosis result to the terminal device.

33. The system for device fault detection according to claim 32, wherein the plurality of cascading apparatuses comprises k levels, wherein:
cascading apparatuses in a first level of the k levels are connected to the plurality of the apparatuses for fault detection in a one-to-one or one-to-many correspondence;
cascading apparatuses in a j-th level of the k levels are connected to cascading apparatuses in a (j+1)-th level of the k levels in another one-to-one or one-to-many correspondence, wherein 1≤j<k; and
each of cascading apparatuses in a k-th level of the k levels is connected to the summarizing apparatus.

34. The system for device fault detection according to claim 32, further comprising a power source, wherein:
the power source is connected to the plurality of the cascading apparatuses, and the plurality of cascading apparatuses supply power via an optical fiber or a net cable to the plurality of apparatuses for fault detection and the summarizing apparatus.

35. The system for device fault detection according to claim 31, further comprising an alarm, wherein the alarm is connected to the summarizing apparatus or the terminal device, and the summarizing apparatus or the terminal device triggers the alarm to alarm in response to receiving the offline diagnosis result.

36. The system for device fault detection according to claim 30, wherein the apparatus for fault detection is installed inside the terminal device in one of following manner:
the apparatus for fault detection is independently installed inside the terminal device;
the apparatus for fault detection is embedded in a main control board of the terminal device; or
the apparatus for fault detection is inserted into a slot of a main control board of the terminal device.

37. The system for device fault detection according to claim 30, wherein the terminal device is installed with a client APP, and the instructions when executed by the processor further configure the apparatus for fault detection to:
receive, from the terminal device via the client APP, at least one of: a machine number of the to-be-tested target, an IP address of the to-be-tested target, a prompt information of the to-be-tested target, a threshold for an error level of the to-be-tested target, a card number of a SIM card installed in the to-be-tested target, a changed program of the system for device fault detection, or a changed keyword of the system for device fault detection.

38. The system for device fault detection according to claim 30, wherein the terminal device is installed with a client APP, and the instructions when executed by the processor further configure the apparatus for fault detection to:
receive a search instruction and a re-check instruction from the terminal device via the client APP, wherein the search instruction is configured to search for a previous fault diagnosis result, and the re-check instruction is configured to test the to-be-tested target again and make repairs on the to-be-tested target.

39. The system for device fault detection according to claim 30, wherein the apparatus for fault detection is encrypted by the terminal device via at least one of: a password, an image, a fingerprint, a face, a voice, or a two-dimensional code.

40. The system for device fault detection according to claim 30, further comprising a hardware communication unit installed in the apparatus for fault detection,
wherein the hardware communication unit includes an IOT-level SIM card or a satellite-positioning locator,
wherein the instructions when executed by the processor further configure the apparatus for fault detection to acquire geographic information of the to-be-tested target and the terminal device; and
wherein the communication unit is configured to send the fault information and the geographic information to the terminal device.
